(19) United States
(12) Patent Application Publication
(10) Pub. No.: US 2006/0120321 A1
(43) Pub. Date: Jun. 8, 2006

(54) System, apparatus, and method for uplink resource allocation

(75) Inventors: Anthony Gerkis, Richmond Hill (CA); Ali Arad, Toronto (CA)

Correspondence Address: KATTEN MUCHIN ROSENMAN LLP, 525 WEST MONROE STREET, CHICAGO, IL, 60661-3693, US

(73) Assignee: SOMA Networks, Inc., San Francisco, CA (US)

(21) Appl. No.: 10/520,705

(22) PCT Filed: Jul. 8, 2003
(86) PCT No.: PCT/CA03/00999

§ 371 Date: Nov. 14, 2005

(30) Foreign Application Priority Data
Jul. 8, 2002 (CA) 2,392,574

(51) Int. Cl. H04Q 7/00

(52) U.S. Cl. 370/329; 370/437

(57) ABSTRACT

A system, method and apparatus for managing uplink radio resources. The RRAM employs selective rate reduction to ensure resources for subscriber stations depending on individual QoS requirements. In response to a request for a new DDCH, the RRAM can drop a subscriber station at a low data rate and no media reservations. In response to traffic measurement reports from the subscriber stations, the RRAM attempts to increase or decrease the data rate of a subscriber station. When there are insufficient uplink resources, RRAM tries to lower the rate of a higher rate subscriber station. Searching for subscriber stations to lower, RRAM starts at the highest rate and continues to search lower data rates until a suitable candidate is found. RRAM also reserves resources for subscriber stations that will not be reallocated to other subscriber stations.

### FIELD OF THE INVENTION

The present invention relates to the field of radio resource allocation within networks. More specifically, the present invention relates to a system, apparatus and method for allocating radio resources to a plurality of subscriber stations transmitting to a radio base station.

### BACKGROUND OF THE INVENTION

In a hybrid network designed to carry both “media” and “data” services, the network needs to provide sufficient capacity (which can be measured as a data rate in bits/s) to meet the needs of each subscriber. Media traffic, such as telephony calls, streaming video or the like, requires a predictable amount of capacity (for example, a telephony call using the G.729AB codec requires 9.6 kbits/s); however, this capacity must be guaranteed. Otherwise, latency will degrade the media service and result in an unsatisfactory subscriber experience. Data traffic, such as HTTP requests and FTP service, can often require large amounts of capacity, but subscribers usually will tolerate brief periods of latency. However, if there is too much latency or the data rate is too slow, then the subscriber will be dissatisfied.

Providing adequate capacity to each subscriber can be challenging as the network possesses a finite amount of resources to provide this capacity. In radio-based networks, the finite resources can include the radio bandwidth, the transmission power levels, etc. If the network includes shared links between subscriber stations, these radio resources and the resulting capacity must be allocated between the subscriber stations. For example, time division multiple access (TDMA) networks allocate slots of time to nodes to transmit over the links and code division multiple access (CDMA) networks can allocate different spreading factors and/or transmission power levels to subscriber stations. For economic reasons a network operator typically wants to allocate as much of the network resources as possible, allowing for a small safety margin, to provide optimal data rates, throughput and economic return. However, the network operator must be careful not to allow excess traffic onto the network as this can cause serious performance and/or stability issues.

Network operators are further concerned with how to allocate the available radio resources between various subscriber stations (whether they are cellular phones, PDAs, laptops with wireless network cards, etc belonging to individual subscribers). Allocation can be performed either fairly between all subscriber stations, or preferentially to reflect different services or service levels for some subscriber stations versus other. For example, media traffic, being generally latency-intolerant should be provided priority over latency-tolerant data traffic like HTTP requests. Similarly, some subscriber stations may have paid for, or otherwise be entitled to, higher average data rates or better service levels than other subscriber stations.

In a centralized radio-based network, a plurality of subscriber stations communicate with a single base station. The base station admits subscriber stations onto the network and allocates a portion of the network's resources to service each subscriber station in both the uplink (many to one) and downlink (one to many) directions. Since the base station is responsible for resource management, it is necessary for the base station to monitor network traffic levels to effectively allocate and/or reallocate radio resources to ensure sufficient capacity for each subscriber station. In the downlink direction (i.e., from the base station to the subscriber station), monitoring is relatively straightforward since all data and media traffic passes directly through the base station enroute to the subscriber stations, allowing the base station to monitor network utilization, allocate resources and schedule traffic accordingly.

Managing uplink (i.e., from the subscriber stations to the base station) traffic is more difficult, as individual subscriber stations have incomplete information on current network traffic as they are typically unaware of other subscriber stations within range of the base station. A radio resource and access manger (RRAM) at the base station is typically required to manage the admission of subscriber stations to the network and the allocation and reallocation of resources between subscriber stations.

RRAM strategies are concerned with admitting subscriber stations to the network, assigning resources to meet a “fairness” or other criteria of resource allocation, and managing usage levels in view of available resources to ensure graceful service degradation and/or stability where usage approaches the maximum threshold. RRAM strategies are typically engineered for a specific physical channel (Ethernet, wireless, etc) to the different types of data structures that the network is expecting to carry (i.e., session-based traffic, bursty IP traffic, etc.).

In a simple implementation, each subscriber station can connect to the base station using an ALOHA-style protocol where the subscriber station simply transmits at will and continually retries at random intervals if the earlier transmission fails. As known to those of skill in the art, in a wireless environment an ALOHA-style protocol is highly inefficient in terms of its utilization of capacity. A number of more sophisticated uplink traffic management schemes have been developed and/or suggested, such as random access polling, resource scheduling and reservation systems. In their article, “Wireless Medium Access Control Protocols”, published in IEEE Communications Surveys (Second Quarter 2000), Ajay Gummalla and John Limb survey a number of MAC strategies to address these problems.

As known to those of skill in the art, a common way to allocate channel resources in a CDMA system is to overprovision the channels. In a conventional IS-95 CDMA system, channels are of a fixed size, designed with significant redundancy for worst-case scenarios. While overprovisioning allows for some robustness in the channel, it is an inefficient use of network resources. Since the channel sized is fixed, the channel is underutilized (in terms of maximum capacity) in better than worst case scenarios. For example, an assigned channel may provide 19.2 kbits/s. Regardless of the channel quality, the subscriber will only ever transmit at 19.2 kbits/s.

Additionally, once a channel is booked, those channel resources are unavailable to the rest of the network, even when nothing is currently being transmitted on the channel. This results in less than optimal use of network resources, particularly when a subscriber station is transmitting bursty traffic such as IP. These problems can be partially mitigated by “overbooking” channels to subscribers. The base station can overbook subscribers without overloading the network due to the statistical distribution of actual usage. However, to ensure stability, over-booking must be prone to periods of under-use where bandwidth is wasted and overuse, where congestion occurs.

Another method of managing uplink traffic is the use of “probabilistic scheduling”. With probabilistic scheduling, the base station provides each subscriber station with a “transmit probability”. This transmit probability is the probability that the subscriber station will transmit a packet. Probabilistic scheduling allows the base station to better manage bursty network traffic. However, one problem with probabilistic scheduling is that all subscriber stations must be provided a channel whether they are transmitting or not, and channels are typically a limited resource in most networks. Furthermore, probabilistic scheduling, as implemented by many 3G systems such as the Third Generation Partnership Program (www.3gpp.org), is designed for “session based” or more connection-like services, and are not optimized for a mix of voice and conventional IP data services.

Another proposed solution, “demand assignment scheduling”, tries to allocate bandwidth based upon the QoS requirements for each traffic channel. A subscriber station requests dedicated bandwidth from a base station, typically using a random access channel (RACH) or other control or signaling channels provided for such a purpose. The base station then schedules bandwidth allocation to each subscriber station based on overall network demand mediated by its own scheduling rules, and authorizes each subscriber station to transmit at appropriate times. It will be appreciated by those of skill in the art, that a great number of different scheduling rules are possible, with each rule set optimized for different type of traffic, QoS requirements and channel structures, but such systems are still essentially connection based.

It is therefore desired to provide a system, apparatus and method which provides for the allocation of uplink resources that efficiently uses the available capacity, can quickly reallocate resources among a potentially large number of active subscribers with a reasonably small amount of resources being devoted to signaling, while ensuring both quality of service (QoS) and fairness (however defined) among different subscribers, and which allows network traffic to degrade gracefully during periods of congestion or resource scarcity for networks carrying a variety of traffic types under different usage scenarios.

### SUMMARY OF THE INVENTION

It is an object of the present invention to provide a novel system, method and apparatus which obviates or mitigates at least some of the above-identified disadvantages of the prior art. According to a first aspect of the present invention, there is provided a method for managing a request for an assignment of at least one uplink dedicated data channel in a network comprising a base station including a radio resource and access manager and a plurality of subscriber stations, where the base station can assign a dedicated data channel from a pool of unassigned dedicated data channels and can allocate a portion of radio resources to assign data rate capacity to an assigned channel, comprising:

a) receiving at the base station a request for a dedicated data channel from one subscriber station of the plurality of subscriber stations;

b) the radio resource and access manager determining if sufficient radio resources are available for providing the requested data channel and if a dedicated data channel is available for assignment from the pool of unassigned dedicated data channels, then
i) if the resources and the dedicated data channel are available, advancing to step (e);
ii) if the necessary resources are not available advancing to step (d);
iii) if the resources are available but the dedicated data channel is not available advancing to step (c);

c) determining whether at least one other subscriber station from the plurality of subscriber stations with an assigned dedicated data channel is eligible to have its the assigned dedicated data channel returned to the pool of unassigned dedicated data channels, then
iv) if at least one other subscriber station is eligible to have its the assigned dedicated data channel returned, returning the assigned dedicated data channel to the pool of unassigned dedicated data channels; then advancing to step (e); or
v) otherwise terminating the method;

d) determining whether at least one other subscriber station with an assigned dedicated channel with a first data rate capacity can be reduced to a lower data rate capacity to make radio resources available and reducing the first data rate capacity to free the associated radio resources available, then
vi) returning to step (b) if such a at least one subscriber station exists;
vii) terminating the method if such a at least one subscriber station does not exist; and

e) assigning the dedicated data channel from the pool of unassigned dedicated data channels to the one subscriber station.

According to another aspect of the invention, there is provided a method for allocating a minimum uplink data rate to a subscriber station in a network comprising a base station and a plurality of subscriber stations, each of the plurality of subscriber stations being independently allocated a current data rate from a set of possible data rates and the data rates requiring varying amounts of uplink radio resources, the method comprising:

a) receiving a reservation request at the base station from one subscriber station of the plurality of subscriber stations;

b) determining whether sufficient uplink radio resources are available to allocate the minimum data rate to the one subscriber station, then
i) if sufficient uplink radio resources are available, advancing to step (e);
ii) if sufficient uplink radio resources are not available, advancing to step (c);

c) determining whether at least one other subscriber station from the plurality of subscriber stations is eligible for a lower data rate, then
iii) if at least one other subscriber station is eligible for the lower data rate, advancing to step (d);
iv) otherwise, ignoring the reservation request and terminating the method;

d) determining which particular subscriber station from the at least one other subscriber stations eligible for the lower data rate will have be moved to the lower data rate and moving the particular subscriber station to the lower data rate, and then returning to step (b); and

e) allocating the minimum data rate to the one subscriber station.

The present invention provides a system for managing uplink resources to ensure an efficient use of available uplink resources and to provide fairness amongst uplink subscriber stations. The RRAM responds to a number of different system events, such as the reception of a high or low traffic volume report, reservation request, or RACH request. In general, the RRAM tries to allocate higher data rates (DDCHs) to subscriber stations requiring them.

The RRAM employs a selective rate reduction policy to ensure sufficient network resources for subscriber stations depending on their individual requirements. In response to a RACH request for a new DDCH, the RRAM can drop a subscriber station at a low data rate and no media reservations. In response to traffic measurement reports from the subscriber stations, the RRAM attempts to increase or decrease the data rate of a subscriber station. When there is insufficient uplink resources available to meet the uplink load/demand (in the case of a high volume traffic measurement report), the RRAM tries to lower the rate of another subscriber station currently transmitting at a higher data rate in order to make room for a rate increase from the first subscriber station. In search for candidate high rate subscriber stations, the base station RRAM starts at the highest rate and checks the oldest subscriber stations at that rate. RRAM continues to search lower data rates until a suitable candidate subscriber station is found. This policy prevents subscriber stations from capturing high rate channels while other low rate subscriber stations are demanding more bandwidth. During congestion periods with many subscriber stations demanding rate increases, high data rate channels are assigned to subscriber stations in a round-robin fashion where each subscriber stations holds a high rate channel only for a fixed period of time.

### BRIEF DESCRIPTION OF THE DRAWINGS

Preferred embodiments of the present invention will now be described, by way of example only, with reference to the attached Figures, wherein:

FIG. 1 is a schematic representation of a wireless network in accordance with an embodiment of the invention;

FIG. 2 is a representation of a communications link as shown in FIG. 1, comprised of multiple channels;

FIG. 3 is a schematic representation of the base station shown in FIG. 1;

FIG. 4 is a schematic representation of one of the subscriber stations shown in FIG. 1;

FIG. 5 is a representation of event messages transmitted between subscriber stations and a base station over the communications link shown in FIG. 2;

FIGS. 6a, 6b, and 6c are state diagrams of channel transitions for the network shown in FIG. 1;

FIG. 7 is a schematic representation of the radio resource manager running on the base station shown in FIG. 3;

FIG. 8 is a flowchart showing how the radio resource manager handles the assignment of an uplink DDCH;

FIG. 9 is a flowchart showing resizing of the uplink DDCH;

FIG. 10 is a flowchart showing how the radio resource manager handles a low traffic volume measurement report;

FIG. 11 is a flowchart showing how the radio resource manager handles a high traffic volume measurement report;

FIG. 12 is a flowchart showing how the radio resource manager handles a request to reserve uplink resources;

FIG. 13 is a flowchart showing how the radio resource manager handles a request to release reserved uplink resources; and

FIG. 14 is a flowchart showing how the radio resource manager handles an uplink load alarm.

### DETAILED DESCRIPTION OF THE INVENTION

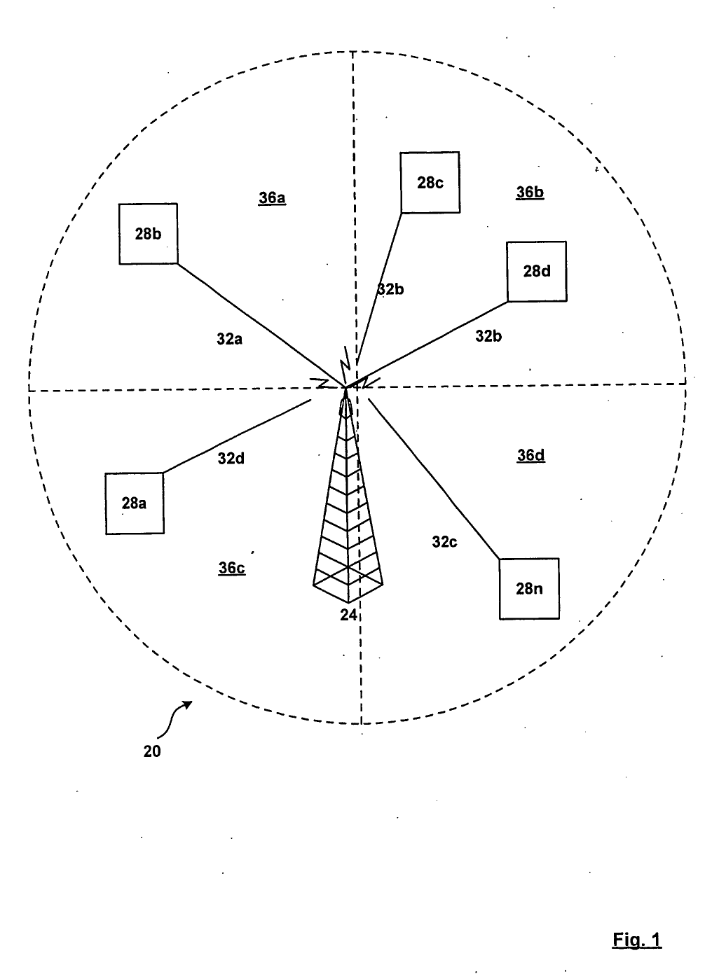

Referring now to FIG. 1, a wireless network for transmitting data is indicated generally at 20. Network 20 includes a radio base station 24 and a plurality of subscriber stations 28a, 28b . . . 28n. In a presently preferred embodiment, radio base station 24 is connected to at least one data telecommunications network (not shown), such as a land line-based switched data network, a packet network, etc., by an appropriate gateway and one or more backhauls (not shown), such as a T1, T3, E1, E3, OC3 or other suitable land line link, or a satellite or other radio or microwave channel link or any other link suitable for operation as a backhaul as will occur to those of skill in the art.

Base station 24 communicates with subscriber stations 28 which, in a present embodiment of the invention, are installed at subscriber premises, as is common in a wireless local loop (WLL) system but could also be nomadic Pr mobile stations as will be apparent. The number ‘n’ of subscriber stations serviced by a base station 24 can vary depending upon a variety of factors, including the amount of radio bandwidth available and/or the configuration and requirements of the subscriber stations 28.

As illustrated in FIG. 1, the geographic distribution of subscriber stations 28 with respect to base station 24 need not be symmetric nor will subscriber stations 28 which are physically located close to one another necessarily experience the same or similar reception qualities due to a variety of factors including the geographic environment (the presence or absence of buildings which can reflect or mask signals), the radio environment (the presence or absence of radio noise sources), etc. Thus, in most circumstances individual subscriber stations 28 served by a base station 24 will have significantly different reception and transmission (hereinafter “transception”) qualities and these transception qualities will change over time. As known to those of skill in the art, subscriber stations 28 can be geographically divided into different sectors 36, formed via beam forming antennas at base station 24 to increase the number of subscriber station 28 that can be served from a single base station location. In such a case, each sector 36 essentially acts as a different base station and base station 24 can manage the network resources in each sector 36 independent of each other sector 36. While FIG. 1 shows only one base station 24, it will further be apparent to those of skill in the art that network 20 can contain multiple, geographically distributed base stations 24, with overlapping sector 36 coverage of subscriber stations 28, and where each subscriber station 28 in an overlapping sector 36 coverage area can select which base station 24 it will be serviced by.

A communication link 32 is established in each sector 36 between base station 24 and each subscriber station 28 in the sector 36 via radio. Communication link 32a carries information to be transferred between base station 24 and subscriber station 28b, communication link 32b carries information to be transferred between base station 24 and subscriber stations 28c and 28d, etc. Communication link 32 can be implemented using a variety of multiple access techniques, including TDMA, FDMA, CDMA or hybrid systems such as GSM, etc. In a present embodiment, data transmitted over communication link 32 is transmitted using CDMA as a multiple access technology and the data is in the form of packets, encapsulated within slotted time frames, the details of which will be discussed in greater detail below.

As used herein, the terms “package”, “packaged” and “packaging” refer to the overall arrangement of the transmission of the data for its reception at an intended destination receiver. Packaging of data can include, without limitation, applying different levels of forward error correcting (FEC) codes (from no coding to high levels of coding and/or different coding methods), employing various levels of symbol repetition, employing different modulation schemes (4-QAM, 16-QAM, 64-QAM, etc.) and any other techniques or methods for arranging data transmission with a selection of the amount of radio (or other physical layer) resources required, the data rate and the probability of transmission errors which are appropriate for the transmission. For example, data can be packaged with rate 1/4 FEC coding (each 1 data bit is transmitted in 4 bits of information) and 16-QAM modulation for transmission to a first intended receiver and packaged with rate 1/2 FEC coding and 64-QAM modulation for transmission to a second intended receiver, which has a better reception-quality than the first.

Communications link 32 operates in both an uplink (from a subscriber station 28 to base station 24) and a downiink direction (from base station 24 to subscriber stations 28). The method of providing both uplink and downlink direction is not particularly limited, and in the present embodiment communications link 32 operates by frequency division duplexing (FDD). However, other methods of providing both an uplink and downlink direction, such as time division duplexing (TDD) and hybrids thereof are within the scope of the invention.

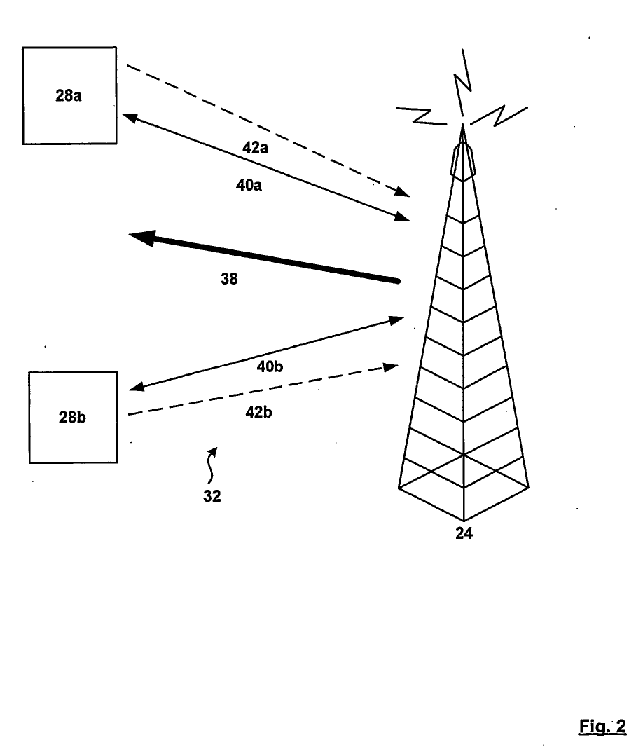

Referring now to FIG. 2, in the current embodiment, communications link 32 is comprised of a plurality of channels, which in the present CDMA implementation, is achieved with orthogonal coding of link 32. In the downlink direction, base station 24 uses a broadcast data channel (BDCH) 38 to provide signaling and data transmissions to all subscriber stations 28 in a sector 36.

Separate DDCHs 40 are set up between base station 24 and each subscriber station 28 which needs to transmit data to base station 24 and DDCHs 40 can be appropriately sized to provide a variety of data rate capacities, as needed. DDCH's are bi-directional, although they can have differing data rate capacities in the uplink and downlink.

Subscriber stations 28 requiring a DDCH 40 (i.e., they do not have a DDCH 40 established) request its setup using a random access channel (RACH) 42. Since RACH 42 is shared between all subscriber stations 28 within a sector 36, a slotted Aloha-style protocol is used as a multiple access technique on RACH 42. Signaling traffic is normally carried from subscriber stations 28 to base station 24 using the DDCH 40 assigned to the subscriber station 28, but some signaling, such as the above-mentioned request for a DDCH, can be carried by RACH 42.

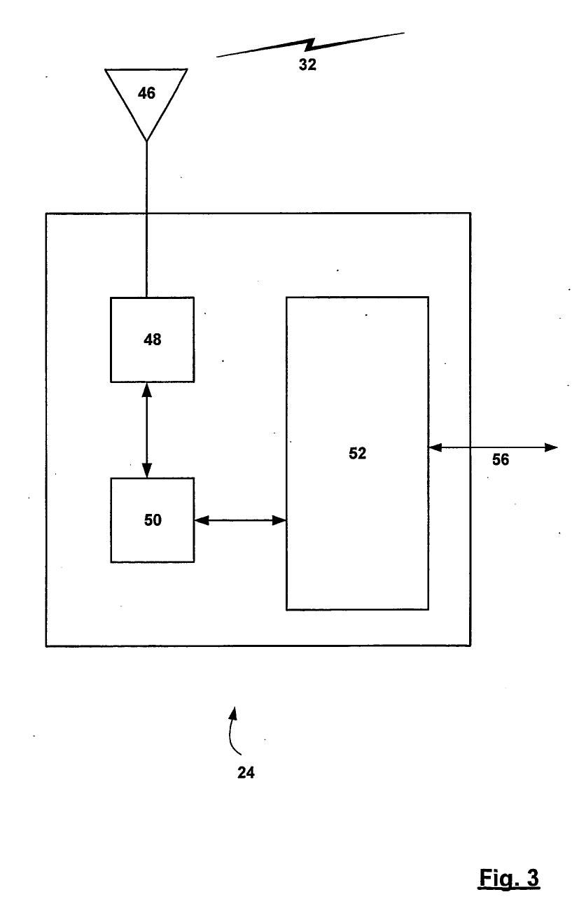

FIG. 3 shows an example of base station 24 in greater detail. For the sake of clarity, FIG. 3 shows an example of a single sector base station 24. However, as described above, multi-sector base stations 24 are also within the scope of the invention. Base station 24 comprises an antenna 46, or antennas, for receiving and transmitting radio-communications over communication communications link 32. Antenna 46 is connected to a radio 48 and a modem 50. Modem 50 is connected to a microprocessor-router assembly 52 such as a Pentium III processor system manufactured by INTEL. Microprocessor-router assembly 52 is responsible for radio resource management of all subscriber stations 28 within its sector 36. It will be understood that assembly 52 can include multiple microprocessors, as desired and/or that the router can be provided as a separate unit, if desired. The router within microprocessor-router assembly 52 is connected to a backhaul 56 in any suitable manner, which in turn connects base station 24 to a data telecommunications network (not shown).

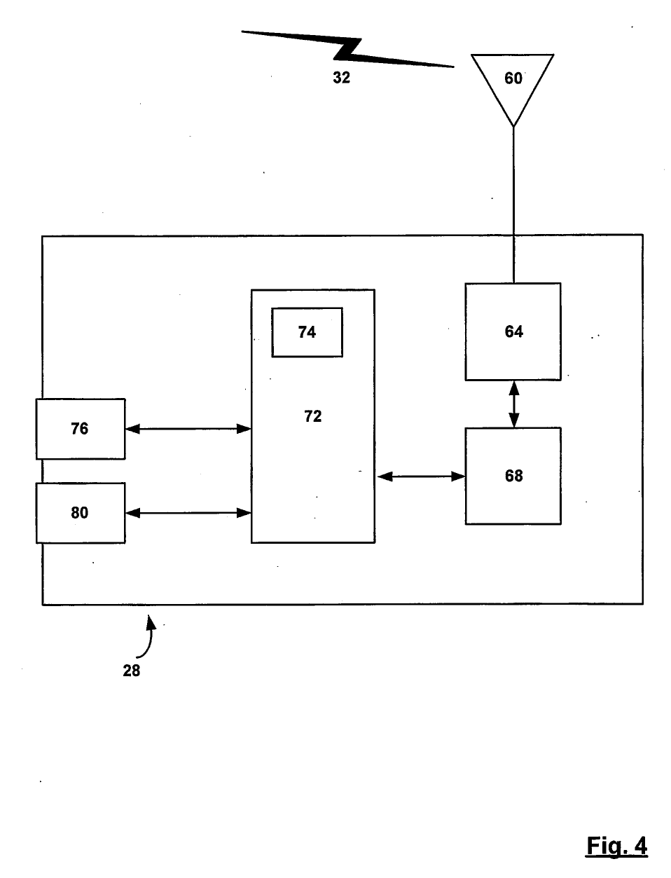

Referring now to FIG. 4, an example of a subscriber station 28 is shown in greater detail. Subscriber station 28 comprises an antenna 60, or antennas, for receiving and transmitting radio-communications over communication communications link 32. Antenna 60 is connected to a radio 64 and a modem 68, which in turn is connected to a microprocessor-assembly 72.

Microprocessor-assembly 72 can include, for example, a StrongARM processor manufactured by Intel, that performs a variety of functions, including implementing A/D-D/A conversion, filters, encoders, decoders, data compressors, de-compressors and/or packet assembly/disassembly. Micro-processor-assembly 72 also includes one or more buffers 74 which store queued traffic waiting for transport to base station 24 via communications link 32.

As shown in FIG. 4, microprocessor-assembly 72 interconnects modem 68 with a data port 76, for connecting subscriber station 28 to a data client device (not shown), such as a personal computer, personal digital assistant or the like which is operable to use data received over communication communications link 32. Accordingly, microprocessor-assembly 72 is operable to process data between data port 76 and modem 68. Microprocessor-assembly 72 is also interconnected to at least one telephony port 80, for connecting subscriber station 28 to a telephony device (not shown) such as a telephone.

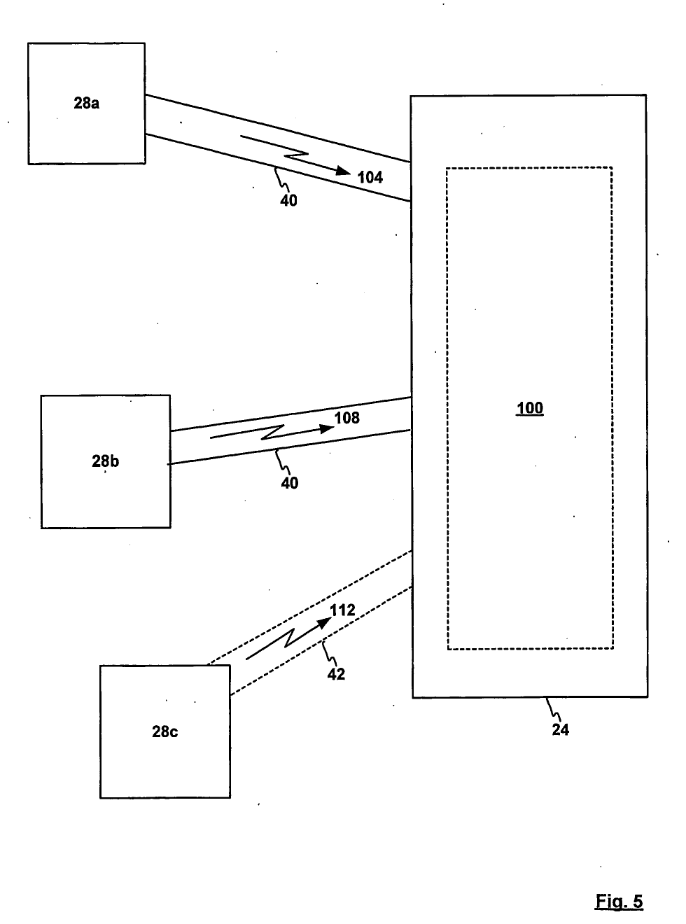

Referring now to FIG. 5, within network 20, the allocation of uplink resources is controlled by a radio resource manager (RRAM) 100 which runs on microprocessor assembly 52 of base station 24 or on any other appropriate computing resource within system 20. RRAM 100 is responsible for assigning subscriber stations 28 a DDCH 40, unassigning DDCHs 40 from subscribers stations and for allocating and reallocating data rate capacity to subscriber stations 28. The data rate assigned to a DDCH 40 can change over the course of its duration, based on the demands from subscriber station 28 and the demands for and amount of available uplink resources, as discussed below. Capacity allocation for media traffic, i.e.—that traffic which requires guaranteed capacity, is achieved through the reservation of uplink resources where a guaranteed minimum data rate is assigned to each DDCH 40 to ensure that the media traffic is transmitted accordingly.

Subscriber stations 28 without a DDCH 40 can request a dedicated channel using a RACH request 112 over RACH 42. In response to a RACH request 112 received from a subscriber station 28, and as described in detail below, RRAM 100 determines if resources are available to create a new DDCH 40 for that subscriber station 28. If the resources are available, RRAM 100 will assign the DDCH 40. If the resources are not available, RRAM 100 can determine if it can lower the data rate capacity of a subscriber station 28 which already has an assigned DDCH 40 or if a subscriber station 28 with an assigned DDCH 40 can be moved to a “camped” state to make the required resources available to open a new DDCH 40 for the requesting subscriber station 28. When a subscriber station 28 is in a camped state, its presence within sector 36 is known to base station 24, but no DDCH 40 is assigned. If a subscriber station 28 transmits a RACH request 112 and does not receive a response from base station 24 within a predetermined period of time, it will retransmit its RACH request 112, provided that subscriber station 28 still requires a DDCH 40.

As part of their normal operations, subscriber stations 28 with assigned DDCHs 40 send traffic volume measurement reports 104 (for data traffic) or reservation requests 108 (for media traffic like telephony services) to indicate their data rate capacity requirements for their DDCH 40. These measurement reports 104 or reservation requests 108 are transmitted over DDCH 40 to base station 24. If a response to these messages is not provided after a predetermined period of time, these messages will be retransmitted, provided that the condition which triggered them still exists.

Specifically, each subscriber station 28 queues packets waiting to be transmitted in buffers 74 and, in a present embodiment, sends a measurement report 104 identifying whenever its queue size in buffers 74 either exceeds a predetermined threshold (indicating a high volume of traffic to be sent) or whenever its queue size drops below a second predetermined threshold (indicating a low volume of traffic to be sent), where the second threshold is lower than the first threshold. In a current embodiment, the queue size in buffers 74 must either exceed the first predetermined threshold or fall below the second predetermined threshold for predetermined periods of time before sending a measurement report 104. This avoids sending a measurement report 104 in response to a momentary spike or lull in the traffic volume to be transmitted.

Subscriber stations 28 can also send a reservation request 108 to reserve a minimum amount of guaranteed uplink resources or to release the minimum amount of guaranteed uplink resources used for media services. Guaranteed uplink resources assigned to a subscriber station will not normally be reassigned away from a subscriber station while in use, and thus can be used to transmit media traffic.

Base station 24 receives measurement reports 104 and reservations requests 108 and generates a system event within RRAM 100. In response to these events, RRAM 100 determines whether data rate modification of DDCH 40 is needed for one or more of subscriber stations 28. If a data rate increase is needed for a subscriber station 28 and if, as described below the necessary resources are, or can be made, available, base station 24 informs that subscriber station 28 of its new uplink DDCH 40 configuration using in band signaling in DDCH 40 and the subscriber station 28 then switches to the new configuration. If the necessary resources for a data rate modification are not available, RRAM 100 ignores the measurement report and will consider the next report. If a decrease is required, RRAM 100 will inform the affected subscriber station 28 of its new uplink DDCH 40 configuration using in band signaling in DDCH 40 and the subscriber station 28 then switches to the new configuration. RRAM 100 responds to these events in sequence as it receives them.

In response to any of the above-mentioned events, RRAM 100 can resize one or more of the uplink DDCHs 40s. For a given subscriber stations 28ᵢ with a DDCH 40, the new rate is selected from a set of preselected rates (R) denoted as {Rⁱₘᵢₙ, R₁, R₂, . . . R_{N}}. R₁, R₂, . . . , R_{N} represent the set of discrete rates possible for DDCH 40, where R₁<R₂< . . . <R_{N} and R_{N} indicates the highest discreet rate available to subscriber station 28ᵢ. The number (N) of rates in R is configurable by a network operator.

Rⁱₘᵢₙ is the minimum uplink rate (e.g., in kbits/s) that can be reserved for any particular subscriber station 28ᵢ and equals the sum of its current uplink reservation(s) for media traffic (if any) plus a minimum data rate allocated for non-media data traffic. As such, for any particular subscriber stations 28, the value of Rⁱₘᵢₙ can vary over time as the amount of reserved uplink capacity changes. It will be apparent that Rⁱₘᵢₙ may be greater than any R value (R₁, R₂ . . . ) less than R_{N} (since R_{N} is the maximum data rate available for subscriber station 28). There is one instance of Rⁱₘᵢₙ per subscriber station 28ᵢ. In the current embodiment, the value of each rate buffer in R (in kbps) is configurable by a network operator.

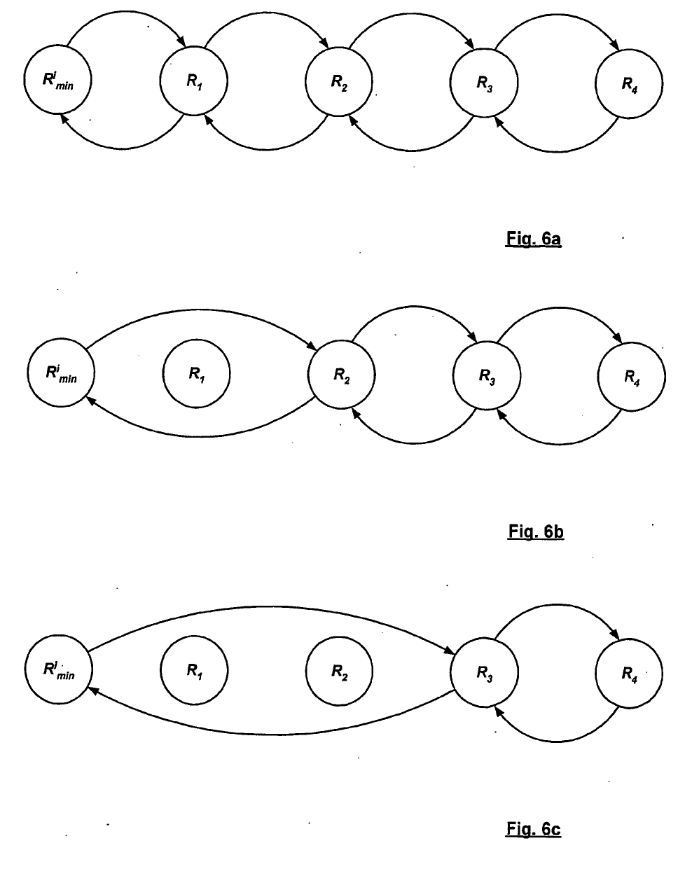

When a DDCH 40 is first assigned to a subscriber station 28ᵢ it is initially assigned a rate equal to its Rⁱₘᵢₙ. When a subscriber station 28ᵢ is granted its first rate increase, it is assigned the minimum R that is greater than Rⁱₘᵢₙ. In following channel transitions, the subscriber station 28ᵢ rate may change step-by-step in the set of {R₁, R₂, . . . , R_{N}} but never drops below its Rⁱₘᵢₙ. FIGS. 6a through 6c show some examples of possible channel transitions in a system with four discrete rates. FIG. 6a shows the set of possible channel transitions where Rⁱₘᵢₙ<R₁. FIG. 6b shows a set of possible transitions where R₁<Rⁱₘᵢₙ<R₂. FIG. 6c shows a set of possible channel transitions where R₂<Rⁱₘᵢₙ<R₃. In each of these three scenarios, subscriber station 28 is always provided with a channel rate at least equal to its Rⁱₘᵢₙ. In the current embodiment, changes between rates require approximately 50 ms to occur and moving out of a camped state (not shown) typically takes longer (approx. 500 ms in the current embodiment) than a transition from rate to rate since a DDCH must be set-up and this requires a long period of time, relative to the time required for a rate change.

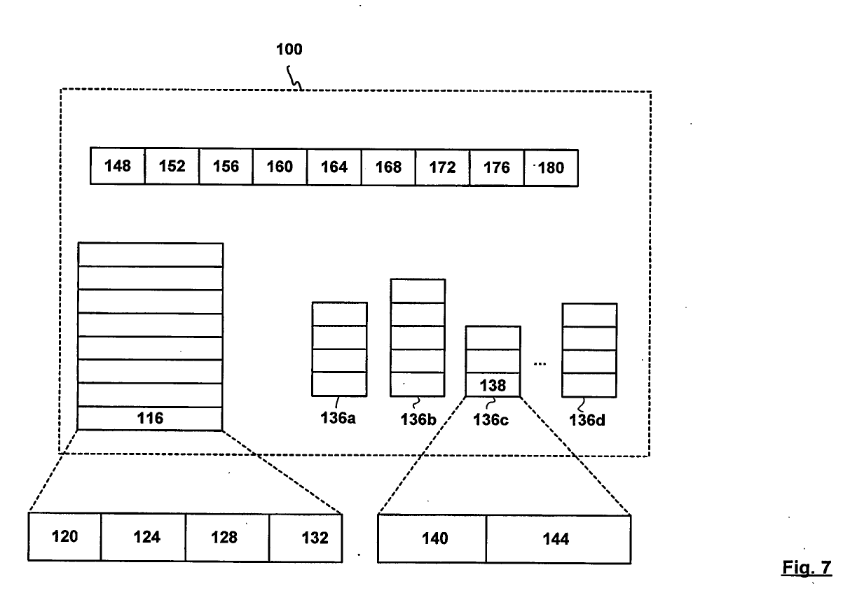

Referring now to FIG. 7, RRAM 100 maintains a list of subscriber records 116 that track information on each subscriber station 28. In a present embodiment, each subscriber record 116 contains at least the following: a unique identifier 120, the minimum uplink rate 124, the uplink loading factor 128, and the rate index 132. Unique identifier 120 is a value unique to its particular subscriber station 28 and is used to track subscriber records 116. Minimum uplink rate 124 stores the Rⁱₘᵢₙ for subscriber station 28ᵢ and is updated whenever Rⁱₘᵢₙ changes. Uplink loading factor 128 stores the current uplink loading metric (Lⁱₘᵢₙ) of an uplink DDCH 40. As known to those of skill in the art, the uplink loading metric represents the loading factor of an allocated data rate adjusted by environmental interference. Lⁱₘᵢₙ equals the uplink loading metric of an uplink DDCH 40 at data rate Rⁱₘᵢₙ. Uplink loading factor 128 is updated whenever the value in minimum uplink rate 124 changes. Rate index 132 stores the index value (RateIdxᵢ) for subscriber station 28ᵢ's current data rate (from the set of R). Rate index 132 ranges from zero to N where zero corresponds to Rⁱₘᵢₙ and N corresponds to the maximum value of R. Rate index 132 updates its value for RateIdxᵢ whenever the data rate on DDCH 40 changes.

RRAM 100 also maintains a plurality of rate lists 136 that track different subscriber stations 28 at each data rate. Each rate list 136 is associated with a specific uplink data rate from the set R, except for rate buffer 136a, which instead contains records of subscriber stations 28 with minimum data reservations (rate index equals zero). Thus, rate list 136a maintains identifiers for each subscriber station 28 that has been assigned a rate of Rₘᵢₙ, rate list 136b maintains records for each subscriber station 28 that has been assigned a rate of R₁, rate list 136c is associated with R₂′ etc. Specifically, each subscriber rate record 138 in rate list 136 contains an identifier 140 that is identical to a corresponding identifier number 120 and a transition time 144, indicating the time that a particular subscriber station 28 moved to its current data rate In the current embodiment, transition time 144 is a timestamp from when subscriber station 28 moved to its current rate. However, other means of determining how long subscriber station 28 has remained at its current rate (such as a counter of transmitted frames) are within the scope of the invention. As described further below, RRAM 100 compares transition time 144 against a minimum holding time to determine whether or not a subscriber station 28 can be moved to a lower data rate. In each rate buffer 136, subscriber rate records 138 are sorted in decreasing order of their age at the current rate level. With each rate change, the subscriber rate record 138 is removed from its current rate list 136, added to the bottom of the new rate list 136 matching the new data rate, and updates transition time 144.

RRAM 100 also maintains a number of values that are used across an entire sector 36. Uplink load 148 is RRAM 100's estimate of the uplink interference (η_{UL}) within sector 36 and measures the sum load of all DDCH40s plus other interference. As will be apparent to those of skill in the art, in a CDMA-based system, the transmissions of each subscriber station 28ᵢ in a sector 36 acts as interference against the transmissions of each other subscriber station 28ᵢ in the sector 36 to the signal received at the receiver of base station 24. Further, other interference sources, such as subscriber stations 28ᵢ in other sectors 36 or subscriber stations 28ᵢ served by other base stations 24 or other sources of radio noise will also be present. Also, as will be apparent to those of skill in the art, the transmit power of each subscriber station 28 is finite and ideally is set as low as possible, while ensuring an acceptable probability of proper reception of its signal, to reduce the extent to each subscriber station 28 interferes with each other subscriber station 28.

As is common with CDMA systems, both open loop and closed loop power control cycles are employed in system 20 to manage the transmission power levels of each subscriber station 28ᵢ. As these cycles vary the power levels of individual subscriber stations 28ᵢ, the interference experienced at the base station receiver against the signal from a particular subscriber station 28ᵢ and/or the interference generated by that subscriber station 28ᵢ with respect to the signals of other subscriber stations 28 received at the base station receiver will vary with time, even when no changes occur in the data transmissions of the particular subscriber station 28ᵢ. Also, allowing one particular subscriber station 28ᵢ to transmit at a given data rate capacity can have a significantly different effect on the interference at the base station receiver than would allowing another particular subscriber station which may have a better or worse radio propagation channel (and thus requiring a markedly different transmission power level).

Thus, RRAM 100 manages the signal to interference ratio that will be experienced at the base station receiver to provide data rate capacity even though there is no fixed relationship between the two quantities.

RRAM 100 periodically measures the received uplink power at antenna 46 and updates η_{UL}. In addition, RRAM 100 updates η_{UL} after each uplink rate transition. In the current embodiment, a single instance of uplink load 148 exists per sector 36.

Admission threshold 152 is the maximum uplink loading value (Tη_{UL}) for which base station 24 will admit additional subscriber stations 28 to network 20. Once uplink load 148 for the sector equals or exceeds admission threshold 152, base station 24 will not admit any additional subscriber stations 28 to the network without reducing uplink load 148. In the current embodiment, a single instance of admission threshold 152 exists per sector 36 and is configurable by a network operator.

Maximum uplink load 156 is the maximum uplink loading value (maxη_{UL}) allowed by RRAM 100. Once uplink load 148 for this sector reaches or exceeds this variable, RRAM 100 begins to reduce the uplink load and will downgrade the rates of DDCHs 40 assigned to subscriber stations 28 or drop DDCHs 40 altogether. A single value of this parameter exists per sector 36. In the current embodiment, maximum uplink load 158 is configurable, although limited by system and environmental factors.

Sector interference ratio 160 stores the ratio of inter-sector interference to intra-sector interference (q) received at antenna 46. Inter-sector interference is interference received from subscriber stations 28 spilling over from a different sector 36 or base station 24. Intra-sector interference refers to interference generated by subscriber stations 28 within the same sector 36. Sector interference ratio 160 is used by RRAM 100 to calculate uplink loads of subscriber stations 28 more accurately by taking into account inter-sector interference. RRAM 100 periodically updates q based on its uplink load measurement. A single value of this parameter exists per sector 36.

Minimum hold time 164 stores the value of the minimum holding time (minHoldingTime) that a subscriber station 28 must stay at a particular data rate (R) before becoming eligible for rate reduction (as described further below). Holding time may be expressed in terms of a number of frames (e.g., 500 frames) or a period of time (e.g., 5 seconds). In a current embodiment, a single instance of this parameter exists per sector 36 and is configurable by a network operator. However, it is contemplated that an instance of minimum holding time 164 could exist per subscriber station 28.

maxULDDCH 168 stores the value of the maximum number of assignable uplink DDCHs available in a sector 36. For example, if maxULDDCH was 30, then that sector could support 30 concurrent subscriber stations 28 with assigned DDCH 40s. In the current embodiment, a single value of this parameter exists per sector 36 and is configurable by a network operator.

minDataRate 172 stores the value of the minimum data rate reserved for the uplink data traffic of a subscriber station 28 with an uplink DDCH 40. minDataRate represents both the initial rate of an uplink DDCH 40 after a RACH request 112 and the minimum rate assigned for data traffic on top of any media reservation. As such, Rⁱₘᵢₙ can be considered equal to media reservations+minDataRate. In the current embodiment, a single value of minDataRate exists per sector.

During the normal course of operation, RRAM 100 responds to different events, such as receiving a measurement report 104, a reservation request 108, or a RACH request 112 received at base station 24, or the generation of an uplink load alarm 114 at base station 24. RRAM 100 uses a number of different MAC strategies to respond to these events under different loading conditions. For example a measurement report 104 indicating a high level of queued data on a subscriber station 28 will cause RRAM 100 to try to increase the data rate of DDCH 40 for that subscriber station, while a measurement report 104 indicating a low level of queued data will cause RRAM 100 to try to decrease the data rate of DDCH 40. These RRAM 100 strategies will be described in greater detail below.

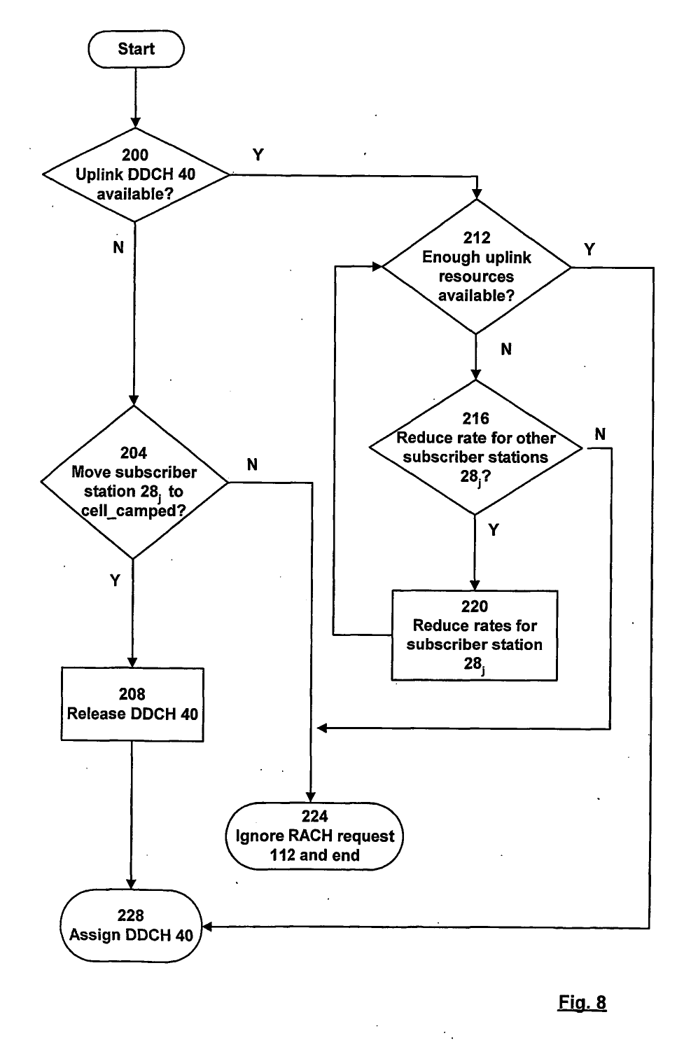

Referring now to FIG. 8, there is shown a method of assigning a DDCH 40 to a subscriber station 28ᵢ in response to a received RACH request 112 at base station 24. The method begins at step 200 where, in response to a RACH request 112 from a subscriber station 28ᵢ, RRAM 100 attempts to provision subscriber station 28ᵢ with an uplink DDCH 40. As described earlier, the total number of uplink DDCHs 40 in a sector 36 cannot exceed the number stored in maxULDDCH 168. If the maximum number of DDCH 40s have already been allocated, then the method advances to step 204 where RRAM 100 will attempt to move another subscriber station 28ⱼ into a camped state and reassign its DDCH 40. Otherwise, the method advances to step 212.

At step 204 RRAM 100 examines rate lists 136 to determine if any subscriber station 28ⱼ with an assigned DDCH 40 can be moved into the camped state. In the current embodiment, subscriber station 28ⱼ will be the oldest subscriber station 28 in the lowest data rate list 136 currently with rate record 138. Furthermore, subscriber station 28ⱼ must have been in its current data rate list 136 longer than minimum holding time 164, and must currently not hold any reserved uplink capacity (i.e., media reservations). If no subscriber station 28 meets these conditions, then the method advances to step 224. Otherwise, if these conditions can be met, the method moves to step 208.

At step 208 RRAM 100 moves selected subscriber station 28ⱼ to the camped state, releasing its assigned DDCH 40. The method advances to step 228.

At step 212 RRAM 100 checks to see if admitting subscriber station 28ᵢ on a new DDCH 40 at minimum data rate 172 will not increase uplink load 148 above admission threshold 152. In the current embodiment, the following condition must be true: η_{UL}+(1+q)×L(minDatarate)≦Tη_{UL} for there to be deemed to be sufficient uplink capacity. RRAM 100 checks to see if the current uplink load 148 plus the additional load of the new DDCH 40 at minDataRate 172, multiplied by sector interference ratio 160 plus one is less than or equal to admission threshold 152. If sufficient uplink capacity is available, then the method advances to step 228 to assign the DDCH 40. If there is insufficient uplink capacity, then the method moves to step 216.

At step 216, RRAM 100 determines whether it can reduce the data rate on any other subscriber station 28ⱼ as to admit a new subscriber station at the minimum rate. RRAM 100 then determines the number of rate reduction steps needed for subscriber station 28ⱼ in order to provide capacity for subscriber station 28ⱼ. RRAM 100 looks for the oldest subscriber rate record 138 in the highest rate list 136 that is assigned a data rate higher than its own R^{j}ₘᵢₙ (i.e., rate index 132 is greater than zero). If at least one subscriber station 28ⱼ is at a rate higher than its own R^{j}ₘᵢₙ, then the method advances to step 220. If no subscriber stations 28ⱼ have a rate higher than their respective R^{j}ₘᵢₙ, then the method advances to step 224.

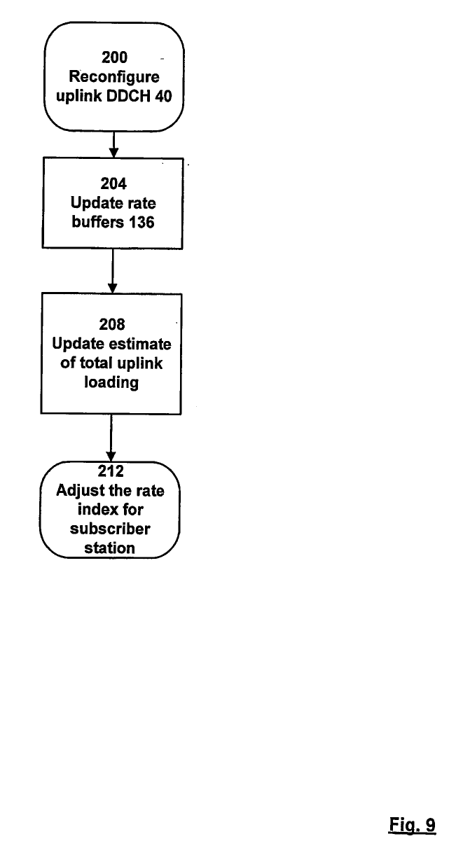

At step 220, the data rate for subscriber station 28ⱼ is reduced one step at a time until one of the following two conditions is met, either sufficient resources have been freed to admit a new DDCH 40 for subscriber station 28ᵢ or the rate reduction will bring subscriber station 28ⱼ down to its R^{j}ₘᵢₙ (rate index equals zero). The first condition is met when η_{UL}+(1+q)×[L(minDataRate)+(L_{newRateIDx}−L_{rateIDx})]≦Tη_{UL}. RRAM 100 checks to see if the current uplink load 148 plus the additional load of the new DDCH 40 for subscriber station 28ᵢ at minimum data rate 172 (multiplied by sector interference ratio 160 plus one) plus the delta in the uplink load caused by subscriber station 28ⱼ (multiplied by sector interference ratio 160 plus one) is less than or equal to admission threshold 152. In the current embodiment, rate reduction occurs in accordance with the method described below with reference to FIG. 9. Once rate reduction is complete, all records in subscriber records 116 and rate lists 136 are updated and the method returns to step 212 to check if sufficient uplink resources have now been freed to admit a new DDCH 40.

At step 224, since either no uplink DDCH 40 is available or sufficient uplink resources are not available, RRAM 100 ignores RACH request 112 and the method ends.

At step 228, as sufficient resources are available, RRAM 100 assigns an uplink DDCH 40 to subscriber station 28ᵢ at the minimum data rate 172, and subscriber station 28ᵢ is entered into subscriber records 116 and rate lists 136. Subscriber station 28i now has a dedicated uplink DDCH 40 and can request media reservations and/or increases in its data rate. The method for assigning a DDCH 40 to a subscriber station 28ᵢ in response to a received RACH request 112 is now complete.

Referring now to FIG. 9, a method for resizing uplink DDCH 40 to a higher or lower data rate for subscriber station 28ᵢ is shown beginning at step 230. At step 230, RRAM 100 reconfigures the uplink DDCH 40 on communication link 32 of subscriber station 28ᵢ moving it to its new data rate R from the set of {Rⁱₘᵢₙ, R₁, R₂, . . . R_{N}}. The method of DDCH 40 reconfiguration is not particularly limited and is known to those of skill in the art.

At step 232, the rate lists 136 are updated to reflect the new uplink DDCH 40. This involves removing subscriber rate record 138 from its current rate list 136 and adding it to the end of its new rate list 136 with an updated transition time 144 set to the current system time.

At step 234, RRAM 100 updates its estimate of uplink load 148 based on the rate change in step 232. RRAM 100 first calculates the change in loading factors for subscriber station 28ᵢ. The delta is then adjusted by sector interference ratio 160 plus one. The adjusted loading factor delta is then added to the current uplink load 148. In the current embodiment, RRAM 100 updates uplink load 148 using the following formula: η_{UL}=η_{UL}+(1+q)×(L_{new}−L_{old}).

At step 236, RRAM 100 adjusts the rate index 132 to the new rate R. At this point RRAM 100 has updated its records and resized uplink DDCH 40. This method is repeated as needed for each resizing of DDCH 40.

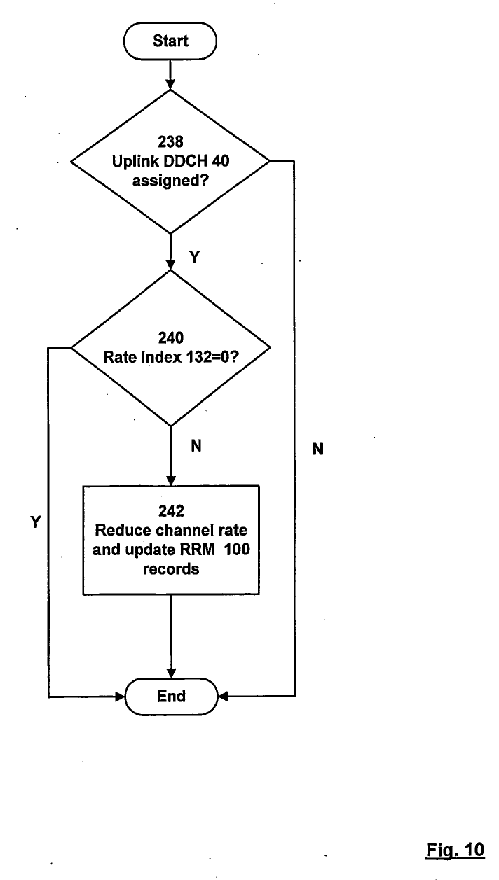

Referring now to FIG. 10, a method for responding to a low traffic volume measurement report 104 transmitted by subscriber station 28ᵢ and received by base station 24 is shown beginning at step 238. A measurement report 104 indicating a small queue size is transmitted by subscriber stations 28 to report that its traffic queue in buffer 74 has fallen to below its second threshold value for a pre-configured period of time, thus indicating a low volume of data traffic to be sent. In response to measurement report 104, RRAM 100 will reduce the size of DDCH 40 accordingly to free up network resources for future demands of uplink resources.

At step 238, RRAM 100 checks to see if subscriber station 28ᵢ is currently assigned an uplink DDCH 40. If subscriber station 28ᵢ does not have an uplink DDCH 40 currently assigned then the method terminates. This condition can occur if RRAM 100 has already decided to close uplink DDCH 40 in response to another event before receiving measurement report 104. Otherwise, the method advances to step 240.

At step 240, RRAM 100 checks to see if rate index 132 for subscriber station 28ᵢ is currently at zero (i.e., subscriber station 28ᵢ is currently at Rⁱₘᵢₙ). If the current rate index 132 is at zero, then the method terminates. Otherwise, the method advances to step 242.

At step 242, RRAM 100 reduces the channel rate R for subscriber station 28ᵢ by one step from the set of {Rⁱₘᵢₙ, R₁, R₂, . . . R_{N}}. RRAM 100 updates subscriber record 116 and moves subscriber rate record 138 to the next lower rate buffer 136, according to the method described above with reference to FIG. 9. RRAM 100 has completed its response for handling a low volume measurement report 104. Future rate reductions will occur if subscriber station 28 continues to send further low traffic volume measurement reports 104.

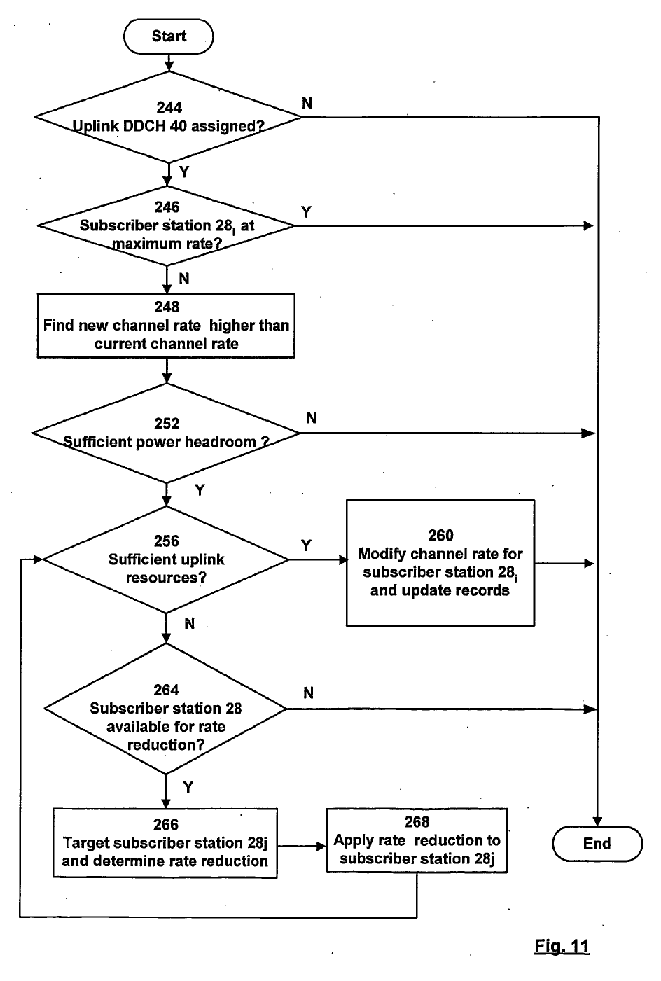

Referring now to FIG. 11, a method for responding to a measurement report 104 received at base station 24 indicating a high volume is shown. A measurement report 104 indicating high traffic volume is transmitted by a subscriber station 28ᵢ to report that its traffic queue in at least one buffers 74, or the aggregate of all of its buffers 74 has risen to a pre-configured value and has been there for a pre-configured period of time, thus indicating a large number of queued packets waiting to be sent. In response, RRAM 100 will check to see if it can increase the size of the assigned DDCH 40 immediately or if it can adjust the size of a DDCH 40 assigned to another subscriber station 28ⱼ and then increase the size of the assigned DDCH 40 to effectively transfer the reclaimed capacity to the subscriber station 28ᵢ which now needs it.

Beginning at step 244, RRAM 100 checks to see if subscriber station 28ᵢ is currently assigned an uplink DDCH 40. If subscriber station 28ᵢ does not have an uplink DDCH 40 currently assigned then the method terminates. This condition can occur if RRAM 100 has already decided to close uplink DDCH 40 in response to another event. Otherwise, the method advances to step 244.

At step 246, RRAM 100 checks to determine if the rate index 132 for subscriber station 28ᵢ is currently at N (i.e., subscriber station 28ᵢ is currently at the maximum data rate). If rate index 132 currently is N (i.e.; at the maximum), then RRAM 100 ignores measurement report 104 and the method terminates. Otherwise, the method advances to step 248.

At step 248, RRAM 100 finds a higher rate R for subscriber station 28ᵢ, where the higher rate R is R_{rateIdx+1} (the higher rate R is one step higher than the current value for R) or, if R is currently at R₀, then the higher rate is the lowest value for R>Rⁱₘᵢₙ (as shown in FIGS. 6b and 6c), with a maximum value of R_{N}.

At step 252, RRAM 100 checks to see if subscriber station 28ᵢ has sufficient power headroom to transmit at the higher rate R. If not, then subscriber station 28ᵢ cannot currently transmit at a higher rate and the method terminates. As known to those of skill in the art, power headroom refers to the maximum available power output (either as limited by system or regulatory constraints) In the current embodiment, the maximum power headroom for subscriber station 28 is known to base station 24 as each subscriber station 28 periodically informs base station 24 of its transmitting power level over DDCH 40. However, the method to determine whether or not there is sufficient power headroom is not particularly limited and other methods will be apparent to those of skill in the art. Otherwise the method advances to step 256.

At step 256, RRAM 100 checks to see if there is sufficient uplink resources available in the network to allow a rate increase for subscriber station 28ᵢ. In the current embodiment, RRAM 100 checks to see if the increase in uplink load 148 (the estimated increase in load in subscriber station 28ⱼ multiplied by sector interference ratio 160 plus one) will bring uplink load 148 equal to or above admission threshold 152. To do this, RRAM 100 checks the following condition: η_{UL}+(1+q)×(L_{new}−L_{old})≦Tη_{UL}. If this condition is true, then there is deemed to be sufficient uplink resources available to allow a rate increase and the method advances to step 260. If sufficient uplink resources are not available in the network to grant the rate increase without bringing uplink load 148 equal to or above admission threshold 152, the method advances to step 264.

At step 260, RRAM 100 increases the channel rate R for subscriber station 28ᵢ by one step from the set of {Rⁱₘᵢₙ, R₁, R₂, . . . R_{N}}. RRAM 100 then updates subscriber record 116 and moves subscriber rate record 138 to the next lower rate buffer 136, according to the method indicated in FIG. 7. The method for responding to a high traffic volume traffic measurement report 104 is complete. Future rate increases may occur when further high traffic volume measurement reports 104 are sent.

At step 264 RRAM 100 checks to see if it can free uplink resources currently assigned to other subscriber stations 28ⱼ in order to allow the rate increase for subscriber station 28ᵢ. In the current embodiment, RRAM 100 determines whether any subscriber station 28ⱼ is transmitting at a rate index 132 (RateIdxⱼ) that is greater than zero (i.e., subscriber station 28ⱼ is transmitting at a data rate higher than its own minimum uplink rate 124) and that is greater than the current RateIdxᵢ of subscriber station 28ᵢ. If both these conditions are met by at least one subscriber station 28ⱼ, then the method advances to step 266. If no subscriber station 28ⱼ meets both these conditions, then RRAM 100 ignores measurement report 104 and does not grant a rate increase to subscriber station 28ᵢ.

At step 266, RRAM 100 determines which subscriber station 28ⱼ (if there is more than one subscriber station 28ⱼ which satisfied the criteria set in step 264) will be targeted for rate reduction. RRAM 100 finds the oldest subscriber station 28ⱼ at the highest data rate currently in use. Starting with highest rate list 136 with a rate record 138, RRAM 100 checks to the rate records of each subscriber station 28ⱼ to find the oldest rate record 138 with a holding time greater than the preselected minimum holding time 164. The first subscriber station 28ⱼ found that meets this condition will be targeted for rate reduction. Once a subscriber station 28ⱼ is targeted for rate reduction the method advances to step 268. If RRAM 100 determines that no subscriber stations 28ⱼ have been at their current data rate for at least minimum holding time 164, then it will not reduce the rate for any active subscriber stations 28ⱼ. Instead, RRAM 100 will ignore the high volume measurement report 104 and exit the method.

At step 268, using the method indicated in FIG. 7, the uplink data rate for subscriber station 28ⱼ is lowered one step in the set of (Rⁱₘᵢₙ, R₁, R₂, . . . R_{N}), i.e. from Rᵢ to Rᵢ₋₁. The method then returns to step 256 to see if sufficient uplink resources are now available. In this way, multiple subscriber stations 28 can have their data rates reduced in order to provide sufficient uplink resources for subscriber station 28ᵢ.

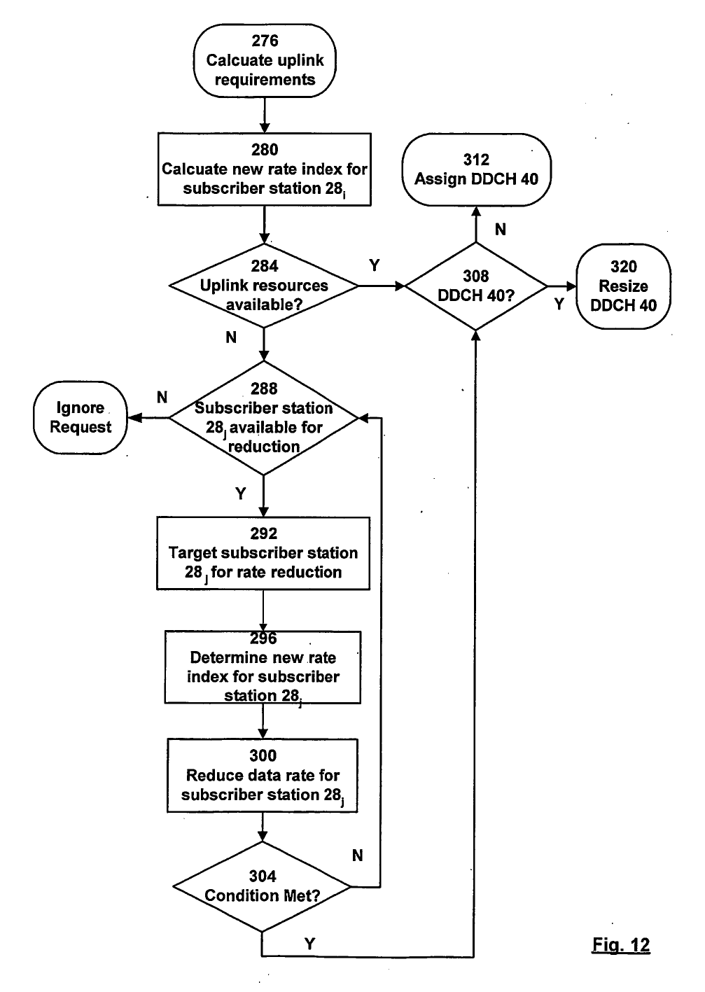

Referring now to FIG. 12, a method to respond to a reservation request 108 to reserve uplink resources begins at 276. A reservation request 108 to reserve uplink resources typically occurs when subscriber station 28ᵢ requires a fixed minimum data rate, particularly for a latency intolerant application such as telephony service. However, other criteria for reserving uplink resources (e.g., guaranteeing QoS terms for a premium customer) are within the scope of the invention. The reservation request 108 can come from a subscriber station 28ᵢ on network 20 or it can originate from elsewhere in network 20 or even outside network 20 (i.e., for an incoming telephone call) with a destination of subscriber station 28ᵢ. In response, RRAM 100 will check to see if it can allocate the desired uplink resources for the media service. A subscriber station 28 may already have reserved uplink resources when it transmits a new reservation request 108. One example of when this situation could occur is when a telephone call is currently set up between subscriber station 28ᵢ and base station 24 and a second telephone call is set up between the two. Another example, again for a telephony call would be a change in voice codec (say, from G.729ab to G.711). In these situations, the existing amount of reserved uplink resources can be enlarged to accommodate the new telephony service. Other examples of reserving additional uplink resources will occur to those of skill in the art.

The method commences at step 276, where RRAM 100 calculates the new minimum uplink rate 124 and new uplink loading factor 128 required to admit this new uplink resource reservation. If subscriber station 28ᵢ has no uplink DDCH 40 (such as an inbound telephony call to a subscriber station 28 that is in a camped state), RRAM 100 sets its new minimum uplink rate 124 to be the data rate required for the media reservation plus the minimum data rate 172 (Rⁱₘᵢₙ=Rⁱ_{newMedia}+minDataRate). If subscriber station 28ᵢ already has an uplink DDCH 40, then its new minimum uplink rate 124 is the sum of its current minimum uplink rate 124 plus data rate required for the media reservation (Rⁱₘᵢₙ=current Rⁱₘᵢₙ+Rⁱ_{newMedia}). For the uplink loading factor 128, the new loading factor is L(new Rⁱₘᵢₙ)

At step 280, RRAM 100 calculates a new rate index 132 for subscriber station 28ᵢ so that R accommodates both the new media reservation and the existing data traffic, to a maximum of R_{N}. The newrateIdx is greater than or equal to the current oldrateIdxᵢ+Rⁱ_{newMedia} within the set of {Rⁱₘᵢₙ, R₁, R₂, . . . R_{N}}.

At step 284, RRAM 100 checks whether or not sufficient uplink resources are available for the requested reservation and that network 20 does not exceed admission threshold 152. RRAM 100 checks to see if the current uplink load 148 plus the delta in loading factor (multiplied by sector interference ratio 160 plus one) is less than or equal to admission threshold 152. In the current embodiment, the following condition is checked: η_{UL}+(1+q)×ΔLᵢ≦Tη_{UL}. If this condition is not met, then sufficient uplink resources are deemed to be not currently available and the method advances to step 288. If this condition is met, then sufficient uplink resources are deemed to be available and the method advances to step 308.

At step 288, RRAM 100 checks to see if it can free any uplink resources elsewhere within network 20. RRAM 100 determines whether or not any subscriber station 28ⱼ with an uplink DDCH 40 is eligible for rate reduction. This condition is true if there is at least one subscriber station 28ⱼ with a data rate higher than its R^{j}ₘᵢₙ stored in rate lists 136. If no subscriber station 28ⱼ is eligible for rate reduction, the media reservation cannot be granted and the method ends. Otherwise, the method advances to step 292.

At step 292, the system determines which subscriber station 28ⱼ will have its uplink data rate reduced. In the current embodiment, the subscriber station 28ⱼ to have its rate reduced is the subscriber station 28ⱼ stored in the highest rate list 136 with the longest transition time 144. Note that it is possible for the subscriber station 28ⱼ that it is targeted for rate reduction to be subscriber station 28ᵢ, i.e., the subscriber station 28 that is requesting a new media reservation. Once a subscriber station 28ⱼ has been selected for rate reduction, then the method advances to step 296.

At step 296, the system determines the new reduced rate index 132 for subscriber station 28ⱼ. The new data rate is the data rate at the maximum rate index 132 for subscriber station 28ⱼ that frees sufficient uplink resources to admit the new media reservation for subscriber station 28ᵢ while maintaining its current reservation requirements for subscriber station 28ⱼ. In the current embodiment, newRateIDxⱼ is calculated to satisfy the following condition: η_{UL}+(1+q)×[ΔLᵢ+(L_{new}−L_{old})]≦Tη_{UL}. The rate index 132 for subscriber station 28ⱼ is reduced one step at a time until the above condition becomes true or rate index 132 equals 0, i.e., subscriber station 28ⱼ will be reduced to R^{j}ₘᵢₙ. Once a new rate index 132 has been determined, the method advances to step 300. Alternatively, it is contemplated that rate index 132 can be reduced a single step (to a minimum value of zero).

At step 300, the rate of the data traffic for subscriber station 28ⱼ is reduced to the new rate index 132 determined in step 296 to allow the new media reservation to be admitted. The data rate for subscriber station 28ⱼ is reduced accordingly, as described in FIG. 8 and RRAM 100 updates rate records 116 and rate lists 136. Once RRAM 100 has reduced the data rate of subscriber station 28ⱼ, the method advances to step 304.

At step 304, RRAM 100 checks to see if sufficient uplink resources have been made available to admit the new media reservation for subscriber station 28ᵢ. If the condition is true (as determined by the formula: η_{UL}+(1+q)×[ΔLᵢ+(L_{new}−L_{old})]≦Tη_{UL}), then the method moves to step 308. Otherwise, the method returns to step 288 to find additional subscriber stations 28ⱼ to target for rate reduction.

At step 308, RRAM 100 is ready to admit the new media reservation. If subscriber station 28ᵢ requires a DDCH 40 to be established (i.e., subscriber station 28ᵢ does not currently have an assigned DDCH 40), the method moves to step 312. If subscriber station 28ᵢ already has an assigned uplink DDCH 40, the method advances to step 320.

At step 312, RRAM 100 assigns a DDCH 40 to subscriber station 28ᵢ. A method for assigning a DDCH 40 is described earlier, with reference to FIG. 8. Once DDCH 40 has been established, subscriber records 116 and rate lists 136 are updated accordingly.

At step 320, RRAM 100 resizes DDCH 40 of subscriber station 28ᵢ to accommodate the new media reservation. In the current embodiment, resizing occurs in accordance with the method described earlier, with respect to FIG. 10. After step 312 or 320, RRAM 100 has finished responding to reservation request 108.

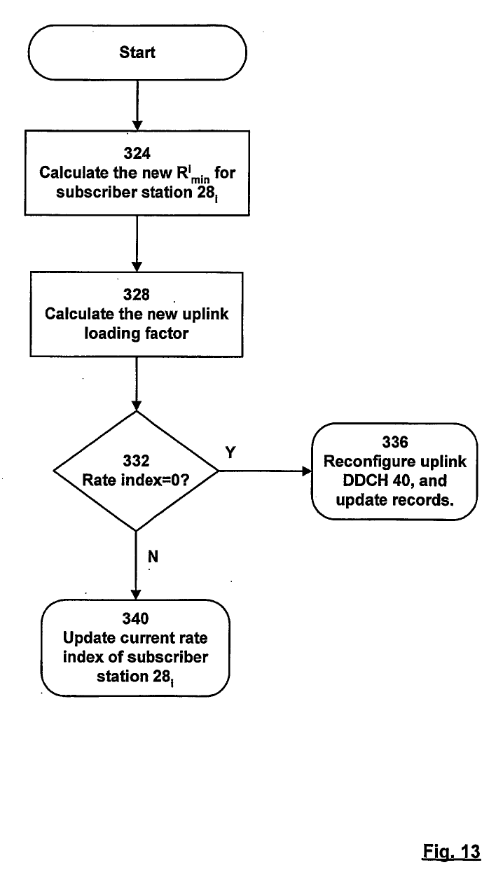

FIG. 13 shows a method to respond to a reservation request 108 from subscriber station 28ᵢ to release reserved uplink resources. Such a situation will typically occur when subscriber station 28ᵢ has completed its media application, such as finishing a telephone call. In response, RRAM 100 will release the reservation of the uplink resources. A subscriber station 28 can close a media reservation while still maintaining another media reservation. In such a scenario, the total amount of the reserved uplink resources simply shrinks.

Beginning at step 324, RRAM 100 calculates the new minimum uplink rate 124. The new minimum uplink rare 124 is the current minimum uplink rate 124 minus the rate of the media reservation to be closed. In the current embodiment, the new Rⁱₘᵢₙ=current Rⁱₘᵢₙ−Rⁱ_{oldMedia}. The method then advances to step 328.

At step 328, RRAM 100 calculates the new uplink loading factor 128 associated with the new minimum uplink rate 124. In the current embodiment, the new uplink loading factor 128 is L(Rⁱₘᵢₙ).

Next, at step 332, RRAM 100 checks whether rate index 132 for subscriber station 28ᵢ is zero. If rate index 132 equals zero, the method will advance to step 336. Otherwise, the method advances to step 340.

At step 336, RRAM 100 reconfigures the uplink DDCH 40 of subscriber station 28ᵢ for the new data rate of Rⁱₘᵢₙ (i.e. rateIDx=0) and updates records stored in rate lists 136. RRAM 100 also updates estimated uplink load 148 so that η_{UL}=η_{UL}+(1+q)×ΔLᵢ. After updating the records, RRAM 100 exits the method.

At step 340, RRAM 100 determines the new rate index 132 as the minimum data rate from the set R operable to carry all remaining media reservations and data traffic (if subscriber station 28ᵢ now has no reserved media traffic, then Rⁱₘᵢₙ, equals minimum data rate 172). The system then modifies the data rate of subscriber station 28ᵢ in accordance with the method described in FIG. 7 and RRAM 100 updates all records in rate lists 136.

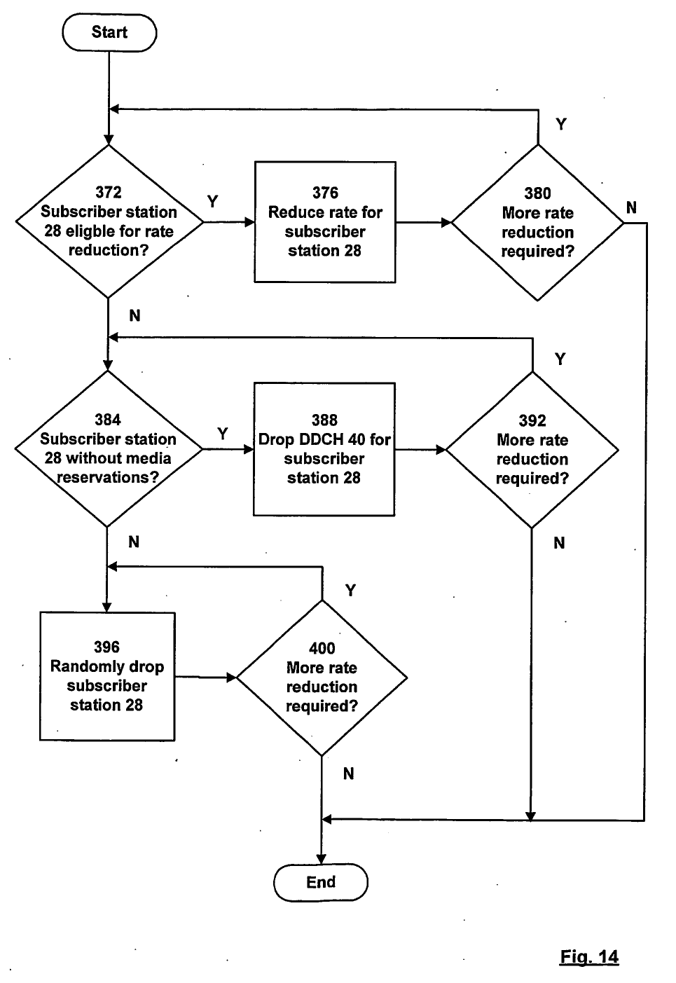

Should an increase in environmental interference or a failure of a hardware or software component of base station 24 occur, the estimated uplink load 148 could potentially exceed maximum uplink load 156 (where η_{UL}≧maxη_{UL}). As described earlier, this situation can have a detrimental effect on the operations of network 20, causing RRAM 100 to generate an uplink load alarm 114. Referring now to FIG. 14, a method of handling such an uplink load alarm 114 starts at step 372.

Beginning at step 372, RRAM 100 determines whether any subscriber stations 28 are eligible for rate reduction. A subscriber station 28ᵢ is eligible for rate reduction if it is at a data rate higher than its Rⁱₘᵢₙ. If one or more subscriber stations 28ᵢ are eligible for rate reduction, the method advances to step 376 where RRAM 100 selects the subscriber station 28ᵢ in the highest rate list 136 which has the highest value in transition time 144. If no subscriber stations 28 meet the crierion for rate reduction, the method advances to step 384.

At step 376, RRAM 100 reduces the data rate for the selected subscriber station 28ᵢ by one step (i.e., from Rᵢ to Rᵢ₋₁) and updates the records in subscriber list 116 and rate lists 136 accordingly. A method for reducing the rate for subscriber station 28ᵢ and updating its records was described above with respect to FIG. 7. After reducing the rate for subscriber station 28ᵢ, the method advances to step 380.

At step 380, RRAM 100 determines whether an uplink load alarm 114 still exists for network 20, i.e.—is a further rate reduction required. If the uplink load alarm 114 still exists (η_{UL}≧maxη_{UL}), then the method returns to step 372. If the uplink load alarm 114 no longer exists (η_{UL}<maxη_{UL}), then the method terminates.

At step 384, RRAM 100 determines whether it can shed any low priority subscriber stations 28 to reduce estimated uplink load 148. Subscriber stations 28 are considered low priority if they do not have any current media reservations. If there are any subscriber stations 28ᵢ with a DDCH 40 that do not have any media reservations (i.e., Rⁱₘᵢₙ=minDataRate), then the method advances to step 388. Otherwise, the method advances to step 396.

At step 388, RRAM 100 drops the connection of the subscriber station 28ᵢ with Rⁱₘᵢₙ=minDataRate that is in the lowest rate list 136 for the longest period of time. Subscriber station 28ᵢ is removed from subscriber list 116 and from rate lists 136. RRAM 100 also updates its estimate of uplink load 148 now that it has dropped subscriber station 28ᵢ using the formula η_{UL}=η_{UL}−(1+q)×Lⁱₘᵢₙ. Once subscriber station 28ᵢ is dropped, then the method advances to step 392.

At step 392, RRAM 100 determines whether an uplink load alarm 114 still exists for network 20. If the uplink load alarm 114 still exists, then the method returns to step 384 to determine if there are any more subscriber stations 28 without media reservations that can be dropped. If the uplink load alarm 114 no longer exists, then the method terminates. Alternatively, it is contemplated that the method could return to step 372 to check if any subscriber stations 28 could have dropped their media reservations.

If at step 384 there are no subscriber stations 28 without media reservations, then the method advances to step 396 where RRAM 100 randomly removes a subscriber station 28. Subscriber station 28ᵢ is removed from subscriber list 116 and from rate lists 136. RRAM 100 also updates its estimate of uplink load 148 so that it removes the loading factor of the dropped subscriber station (multiplied by sector interference ratio 160 plus one), so that η_{UL}=η_{UL}−(1+q)×Lⁱₘᵢₙ. Once the connection to subscriber station 28ᵢ is removed, then the method advances to step 400.

At step 400, RRAM 100 determines whether an uplink load alarm 114 still exists for sector 36. If the uplink load alarm 114 still exists, then the method returns to step 396 to randomly drop another subscriber station 28. Alternatively, the method could return to step 372. If the uplink load alarm condition no longer exists, then the method terminates.

The present invention provides a system for managing uplink resources to ensure an efficient use of available uplink resources, and to provide fairness amongst uplink subscriber stations 28. RRAM 100 responds to a number of different system events, such as the reception of a high or low traffic volume report 104, reservation request 108, or RACH request 112. In general, RRAM 100 tries to allocate the minimum data rate DDCH 40 possible to subscriber stations 28 that maintains the queue in buffers 74 between the first and second threshold.

RRAM 100 employs a rate reduction policy to implement “fairness” (as defined by the network operator) between subscriber stations 28. When there is insufficient uplink resources available, RRAM 100 tries to lower the rate of another subscriber station 28 currently transmitting at a higher data rate in order to make room for a rate increase from the first subscriber station 28. In search for candidate high rate subscriber station 28s, RRAM 100 starts at the highest rate list 136. RRAM 100 continues to search lower data rates until a suitable candidate subscriber station 28 is found. This policy prevents subscriber stations 28 from capturing high data rates while other low rate subscriber stations 28 are demanding more bandwidth. During congestion periods with many subscriber station 28s demanding rate increases, high data rates are assigned to subscriber stations 28 in a manner where each subscriber station 28 with traffic queues above the first threshold holds a high data rate only for a fixed period of time before being pushed down by a different subscriber station 28. In response to a RACH 112 request for a new DDCH 40, RRAM 100 can drop a subscriber station 28 at a low data rate with no media reservations. In response to traffic measurement reports from the subscriber stations, RRAM attempts to increase the data rate of a subscriber station.

The above-described embodiments of the invention are intended to be examples of the present invention and alterations and modifications may be effected thereto, by those of skill in the art, without departing from the scope of the invention which is defined solely by the claims appended hereto.

1. A method for managing a request for an assignment of at least one uplink dedicated data channel in a network comprising a base station including a radio resource and access manager and a plurality of subscriber stations, where said base station can assign a dedicated data channel from a pool of unassigned dedicated data channels and can allocate a portion of radio resources to assign data rate capacity to an assigned channel, comprising:
a) receiving at said base station a request for a dedicated data channel from one subscriber station of said plurality of subscriber stations;
b) said radio resource and access manager determining if sufficient radio resources are available for providing said requested data channel and if a dedicated data channel is available for assignment from said pool of unassigned dedicated data channels, then
i) if said resources and said dedicated data channel are available, advancing to step (e);
ii) if said necessary resources are not available advancing to step (d);
iii) if said resources are available but said dedicated data channel is not available advancing to step (c);
c) determining whether at least one other subscriber station from said plurality of subscriber stations with an assigned dedicated data channel is eligible to have its said assigned dedicated data channel returned to said pool of unassigned dedicated data channels, then
iv) if at least one other subscriber station is eligible to have its said assigned dedicated data channel returned, returning said assigned dedicated data channel to said pool of unassigned dedicated data channels; then advancing to step (e); or
v) otherwise terminating the method;
d) determining whether at least one other subscriber station with an assigned dedicated channel with a first data rate capacity can be reduced to a lower data rate capacity to make radio resources available and reducing said first data rate capacity to free said associated radio resources available, then
vi) returning to step (b) if such said at least one subscriber station exists;
vii) terminating the method if such said at least one subscriber station does not exist; and
e) assigning said dedicated data channel from said pool of unassigned dedicated data channels to said one subscriber station.

2. The method of claim 1, where said at least one other subscriber station in step (c) is eligible only if it has no reserved uplink resources.

3. The method of claim 2, where said at least one other subscriber station in step (c) is eligible only if it has a data rate as least as low as any other subscriber station with no reserved uplink resources.

4. The method of claim 3, where said at least one other subscriber station in step (c) is eligible only if it has been at said data rate for at least as long any other subscriber station with no reserved uplink resources.

5. The method of claim 4, where said at least one other subscriber station in step (c) is eligible only if it has been at said data rate for at least a pre-selected minimum holding time.

6. A method for managing the allocation of uplink resources in a network comprising a base station and a plurality of subscriber stations, each of said plurality of subscriber stations being independently allocated uplink resources to provide current data rate from a set of possible data rates, said method comprising:
a) receiving a message at said base station from one subscriber station of said plurality of subscriber stations, and
i) if said message indicates one of high amount of traffic waiting to be sent and low amount of traffic waiting to be sent, determining a desired data rate from said set of possible data rates for said one subscriber station, where said desired data rate is a different data rate than said current data rate;
ii) otherwise ignoring said message and terminating the method;
b) determining whether sufficient uplink resources are available to grant said desired data rate to said one subscriber station, then
iii) if sufficient uplink resources are available, advancing to step (e)
iv) if sufficient network are not available, advancing to step (c);
c) determining whether at least one other subscriber station from said plurality of subscriber stations is eligible for a lower data rate, said at least one other subscriber station being eligible for a lower data rate if said current data rate for said at least one other subscriber station is greater than a minimum data rate allocated to said at least one subscriber station, then
v) if at least one other subscriber station is eligible for said lower data rate, advancing to step (d);
vi) otherwise, ignoring said message and terminating the method;
d) determining which particular subscriber station from said at least one other subscriber stations eligible for said lower data rate will be subjected to said rate reduction and moving said particular subscriber station to said lower data rate, and then returning to step (b); and
e) moving said one subscriber station to said desired data rate from said current data rate for said one subscriber station.

7. The method of claim 6, where said at least one other subscriber station in step (c) is eligible only if it has been at said data rate for at least pre-selected minimum holding time.

8. The method of claim 6, where said desired data rate is a data rate from said set of data rates and is one of one step higher and one step lower than said current data rate in said set of data rates.

9. The method of claim 6, where said minimum data rate is a sum of any reserved uplink resources on said at least one other subscriber station.

10-13. (canceled)

14. A method for managing uplink load in a network having a predetermined maximum uplink load level, said network comprising a base station and a plurality of subscriber stations, each of said plurality of subscriber stations being independently allocated a current data rate from a set of possible data rates, the method comprising:
a) determining said total uplink load in said network;
b) if said load is within a pre-selected range of said maximum uplink load level, determining if an eligible subscriber station exists within said plurality of subscriber stations, said eligible subscriber station being capable of having its data rate reduced from its present data rate to a lower data rate in said set of possible data rates, and reducing said present data rate to said lower data rate and returning to step a);
c) otherwise, if said load is within a pre-selected range of said maximum uplink load level and no eligible subscriber station exists, determining at least one subscriber station whose present data rate will be reduced to zero and reducing said present rate to zero and returning to step (a).

15. The method of claim 14 where in step (c), said determined subscriber station is selected randomly from said plurality of subscriber stations.

16. The method of claim 15, where said eligible subscriber station in step (a) is one of said plurality of subscriber stations without any reserved uplink resources with a data rate at least as high as any other subscriber station without reserved uplink resources.

17. The method of claim 15 where said lower data rate in step (a) is one step lower in said set of possible data rates.

18. The method of claim 15, where said eligible subscriber station in step (b) is one of said plurality of subscriber stations without any reserved uplink resources with a data rate at least as high as any other subscriber station without reserved uplink resources.

19-40. (canceled)
